(19) United States
(12) Patent Application Publication
(10) Pub. No.: US 2022/0029812 A1
(43) Pub. Date: Jan. 27, 2022

(54) COLLATION SYSTEM, CLIENT AND SERVER

(71) Applicant: NEC Corporation, Minato-ku, Tokyo (JP)

(72) Inventors: Hiroto TAMIYA, Tokyo (JP); Toshiyuki ISSHIKI, Tokyo (JP); Masahiro NARA, Tokyo (JP); Haruna FUKUDA, Tokyo (JP)

(73) Assignee: NEC Corporation, Minato-ku, Tokyo (JP)

(21) Appl. No.: 17/311,745

(22) PCT Filed: Dec. 12, 2018
(86) PCT No.: PCT/JP2018/045778

§ 371 Date: Jun. 8, 2021

(51) Int. Cl. H04L 9/32; H04L 9/08; H04L 9/00

(52) U.S. Cl. CPC H04L 9/3231; H04L 9/3271; H04L 9/008; H04L 9/0869; H04L 9/0825

(57) ABSTRACT

A client 30 includes a concealed information storage unit 31 which stores concealed information obtained by concealing registered information by use of a public key, an information generation unit 32 which, on the basis of the concealed information and a random number, generates, by use of the public key, generation source information that is information for generating a challenge, and a response computation unit 33 which, by use of the challenge sent from a server 40, collation information to be collated against the registered information, and a random number, computes a response corresponding to the challenge. The server 40 includes a key storage unit 41 which stores a secret key corresponding to the public key, and a challenge generation unit 42 which generates the challenge on the basis of the generation source information sent from the client 30.

### TECHNICAL FIELD

The present invention relates to a collation system, a collation method, and a client, a server, a program for a client, and a program for a server, applied to the collation system.

### BACKGROUND ART

One example of authentication is biometrics. “Biometrics” is a method of personal authentication in which the biometric information of the authenticated person is collated with the biometric information of the registrants to confirm whether or not the authenticated person is matched with any one of the registrants.

“Biometric information” is data extracted from some characteristics of an individual regarding body and behavior, or data generated by transforming the extracted data. This data is sometimes referred to as a feature value.

A “template” is data generated from the biometric information (hereinafter, referred to as registered information) of a registrant that is stored in advance for biometric authentication.

When biometric authentication is performed in a client-server system, there are two ways. One is to store the template in the client, and the other is to store the template in the server.

Patent literature (PTL) 1 describes a collation system which makes leakage or spoofing, etc., avoidable and heightens safety with regard to a binary vector.

PTL 2 describes an authentication device that authenticates the validity of a subject ciphertext generated by encrypting a plaintext using homomorphic encryption processing.

FIDO (Fast ID entity Online) is an example of storing a template in a client. In FIDO, a template is stored in the client in advance. When the biometric information of the user (the authenticated person) currently using the client is input to the client, the client determines whether the authenticated person corresponds to a registrant or not on the basis of the input biometric information and the template. When the client determines that the authenticated person corresponds to the registrant, the server determines whether the signature key (secret key) of the client and the verification key (public key) of the server are a pair of keys on the basis of the signature generated by the client using the signature key. In other words, in FIDO, when biometric authentication is successful at the client and verification of the signature of the client is successful at the server, the user (authenticated person) is finally determined to have been successfully authenticated.

In addition, in FIDO, the encrypted biometric information of the registrant is stored in advance in the client as a template. The key for decrypting the encrypted information is also stored in the client. When the biometric information of the authenticated person is input to the client, the client decrypts the template using the key, and determines whether the authenticated person corresponds to a registrant or not using the decrypted biometric information and the input biometric information.

In some cases, encrypted biometric information is stored in an IC (Integrated Circuit) chip of a cash card.

Here, what is protected as personal information is explained under “Act on the Protection of Personal Information (hereinafter, referred to as “personal information protection law”) in Japan. The personal information protection law in Japan stipulates that biometric information which is information that can identify an individual is the personal information. Furthermore, the personal information protection law stipulates that personal information managed in an electronic database or a paper database is an object to protection under the personal information protection law.

In the case where templates are stored in a server, it can be said that the templates of individual users using individual clients are stored as a database in a common server. Therefore, the templates stored in the server are objects to protection under the personal information protection law.

On the other hand, in the case of storing templates in a client, the client stores the templates of one or a few users who use the client. Accordingly, it cannot be said that the templates are stored as a database. Therefore, the templates stored in the client may not be protected by the personal information protection law.

### CITATION LIST

### Patent Literature

PTL 1: International Publication No. WO 2018/110608

PTL 2: Japanese Patent Application Laid-Open No. 2014-220661

### SUMMARY OF INVENTION

### Technical Problem

Even when the template is stored in the client, it is preferable to prevent the leakage of the biometric information of the registrant (i.e., registered information), taking into account possibility that the template may be leaked from the client. In other words, it is preferable to prevent the leakage of the registered information from the template.

In addition, not only in the case of authentication by a biometric, but also in the case of authentication by a password or by a secret key stored in an IC card etc., it is preferable to prevent the leakage of registered information from the client, when a template generated from the password or secret key being the registered information is stored in the client of the client-server system.

Another reason why it is preferable to prevent the leakage of registered information is that if the registered information is leaked, there is a possibility that the server will be spoofed using the leaked registered information. However, even if all possible security measures are implemented, it is difficult to completely eliminate the possibility of registered information leaks from the client-server systems.

Therefore, it is an object of the present invention to provide a collation system, a collation method, and a client, a server, a program for a client, and a program for a server, applied to the collation system, which can prevent replay attacks in an authentication process.

### Solution to Problem

A collation system according to the present invention is a collation system which employs a challenge response method, including a client and a server, wherein the client includes: a concealed information storage unit which stores concealed information obtained by concealing registered information by use of a public key, an information generation unit which, on the basis of the concealed information and a random number, generates, by use of the public key, generation source information that is information for generating a challenge, and a response computation unit which, by use of the challenge sent from the server, collation information to be collated against the registered information, and the random number, computes a response corresponding to the challenge, and wherein the server includes: a key storage unit which stores a secret key corresponding to the public key, and a challenge generation unit which generates the challenge on the basis of the generation source information sent from the client.

Furthermore, a client according to the present invention is a client which employs a challenge response method, includes: a concealed information storage unit which stores concealed information obtained by concealing registered information by use of a public key, an information generation unit which, on the basis of the concealed information and a random number, generates, by use of the public key, generation source information that is information for generating a challenge, and a response computation unit which, by use of the challenge sent from the server which employs the challenge response method, collation information to be collated against the registered information, and the random number, computes a response corresponding to the challenge.

Furthermore, a server according to the present invention is a server which employs a challenge response method, includes: a key storage unit which stores a secret key corresponding to a public key had by a client which employs the challenge response method, and a challenge generation unit which generates a challenge on the basis of generation source information that is information for generating the challenge, wherein the generation source information is generated, by use of the public key, on the basis of concealed information obtained by concealing registered information by use of the public key and a random number, and sent from the client.

Furthermore, a collation method according to the present invention is a collation method in a collation system which employs a challenge response method, including a client and a server, wherein the client stores concealed information obtained by concealing registered information by use of a public key in a concealed information storage unit, generates, on the basis of the concealed information and a random number, by use of the public key, generation source information that is information for generating a challenge, and sends generated generation source information to the server, wherein the server stores a secret key corresponding to the public key in a key storage unit, generates the challenge on the basis of the generation source information sent from the client, and sends generated the challenge to the client, and wherein the client, by use of the challenge sent from the server, collation information to be collated against the registered information, and the random number, computes a response corresponding to the challenge.

Furthermore, a collation method according to the present invention is a collation method in a client which employs a challenge response method, including: storing concealed information obtained by concealing registered information by use of a public key in a concealed information storage unit, generating, on the basis of the concealed information and a random number, by use of the public key, generation source information that is information for generating a challenge, and computing, by use of the challenge sent from the server which employs the challenge response method, collation information to be collated against the registered information, and the random number, a response corresponding to the challenge.

Furthermore, a collation method according to the present invention is a collation method in a server which employs a challenge response method, including: storing a secret key corresponding to a public key had by a client which employs the challenge response method in a key storage unit, and generating a challenge on the basis of generation source information that is information for generating the challenge, wherein the generation source information is generated, by use of the public key, on the basis of concealed information obtained by concealing registered information by use of the public key and a random number, and sent from the client.

Furthermore, a program for a client according to the present invention, implemented in a computer including a concealed information storage unit which stores concealed information obtained by concealing registered information by use of a public key and performing as the client which employs a challenge response method, causes the computer to execute a generating process of generating, on the basis of the concealed information and a random number, by use of the public key, generation source information that is information for generating a challenge, and a computation process of computing, by use of the challenge sent from the server which employs the challenge response method, collation information to be collated against the registered information, and the random number, a response corresponding to the challenge.

Furthermore, a program for a server according to the present invention, implemented in a computer including a key storage unit which stores a secret key corresponding to a public key had by a client which employs the challenge response method and performing as the server, causes the computer to execute a generating process of generating a challenge on the basis of generation source information that is information for generating the challenge, wherein the generation source information is generated, by use of the public key on the basis of concealed information obtained by concealing registered information by use of the public key and a random number, and sent from the client.

### Advantageous Effects of Invention

According to the present invention, it is possible to prevent replay attacks in the authentication process.

### BRIEF DESCRIPTION OF DRAWINGS

FIG. 1 is a block diagram showing a configuration example of a collation system in an exemplary embodiment of the present invention.

FIG. 2 is a flowchart showing an example of processing when storing a template in advance in a concealed information storage unit 150 of a client 100.

FIG. 3 is a flowchart showing an example of processing when authentication is performed.

FIG. 4 is an explanatory diagram showing an example of the specific authentication process in a collation system 10.

FIG. 5 is an explanatory diagram showing another example of the specific authentication process in the collation system 10.

FIG. 6 is a schematic block diagram showing a configuration example of a computer for each of the client 100 and the server 200 in aforementioned exemplary embodiment or its specific example.

FIG. 7 is a block diagram showing an outline of a collation system according to the present invention.

### DESCRIPTION OF EMBODIMENTS

Hereinafter, an exemplary embodiment of the present invention will be described with reference to the drawings. In the following description, the case where the collation system of the present invention is applied to biometric authentication is used as an example. However, the collation system of the present invention may be applied to authentication other than biometric authentication.

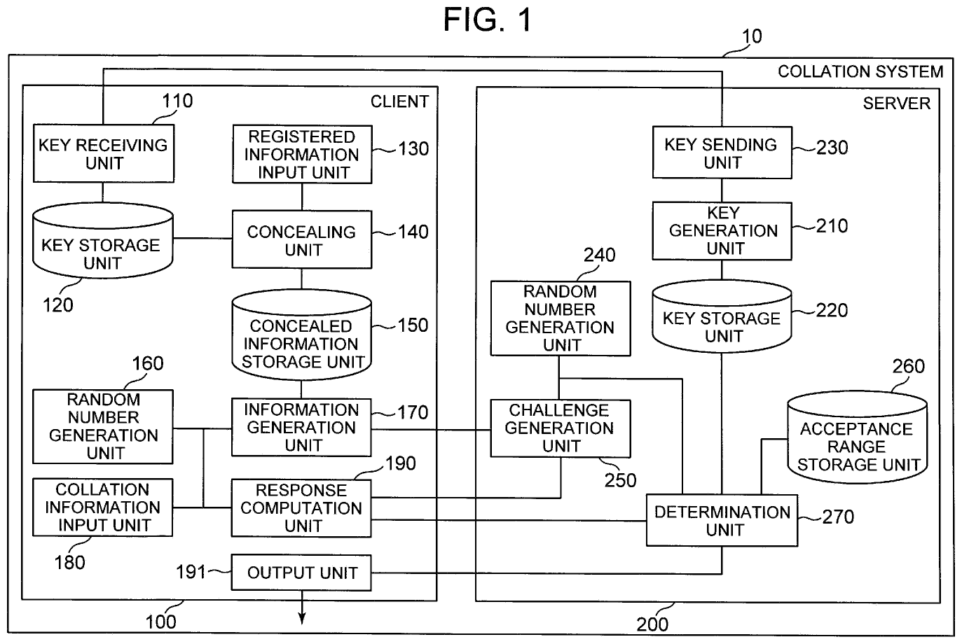

FIG. 1 is a block diagram showing a configuration example of a collation system in an exemplary embodiment of the present invention. The collation system 10 shown in FIG. 1 comprises a client 100 and a server 200. Although one client 100 is shown in FIG. 1, there may be multiple clients 100. The client 100 and the server 200 can communicate with each other via a communication network.

For example, suppose that an attacker wiretaps the registered information sent from the client to the server. Further, suppose when the attacker executes a replay attack which retransmits wiretapped registered information to the server, the server accepts the retransmitted registered information as the registered information sent by the client.

In this case, by the above replay attack, the attacker can spoof as the client and successfully authenticate to the server. If the attacker succeeds in spoofing, an unauthorized login and other damage will occur.

In the collation system 10 of the present exemplary embodiment, a challenge response method is implemented so that spoofing is prevented. Specifically, the server 200 uses the challenge response method to cause the client 100 to compute a response that includes closeness between the registered information and the collation information (information input for being collated with the registered information) described below, so that the value of the response is changed for each authentication.

When the value of the response is changed for each authentication, even if an attacker wiretaps the value of the response, the wiretapped value can no longer be used in the next authentication, thus preventing a replay attack. The following is a description of each component of the collation system 10 of the present exemplary embodiment.

As shown in FIG. 1, the client 100 comprises a key receiving unit 110, a key storage unit 120, a registered information input unit 130, a concealing unit 140, a concealed information storage unit 150, a random number generation unit 160, an information generation unit 170, a collation information input unit 180, a response computation unit 190, and an output unit 191.

The key receiving unit 110 receives a public key generated by the server 200 and sent by the server 200, and stores the public key in the key storage unit 120. Hereinafter, this public key is referred to as pk.

The key storage unit 120 is a storage device that stores the public key pk.

The registered information input unit 130 receives input of registered information. In the present exemplary embodiment, biometric information of a registrant is input into the registered information input unit 130 as registered information.

In the present exemplary embodiment, the explanation is based on the case where the registered information and the collation information described below are represented by vectors of a common dimension.

The registered information input unit 130 may be an input device corresponding to the registered information. For example, when biometric information extracted from a fingerprint is used as registered information, the registered information input unit 130 may be an input device that reads the fingerprint, extracts a vector that becomes registered information from the fingerprint, and accepts input of the vector. The registered information input unit 130 may also be an input device into which a vector that serves as registered information is input directly.

In the present exemplary embodiment, the biometric information may be extracted from iris, retina, face, blood vessels (veins), palm print, voice print, or a combination of these, other than fingerprint. The biometric information may also be extracted from other information that can identify a living body, other than the examples described above.

The vector corresponding to the biometric information (registered information) of the registrant input into the registered information input unit 130 is denoted by X.

The concealing unit 140 conceals the biometric information X of the registrant input into the registered information input unit 130, and stores the information (referred to as concealed information) generated by concealing biometric information X in the concealed information storage unit 150. The concealed information storage unit 150 is a storage device that stores the concealed information.

This concealed information is data generated from the biometric information of the registrant, which is stored in advance for biometric authentication. Therefore, this concealed information is a template. The public key pk is not a template because the public key pk stored in the key storage unit 120 is not data generated from the biometric information of the registrant.

In the present exemplary embodiment, encryption will be used as a specific example of concealment. Therefore, the concealing unit 140 encrypts the biometric information X of the registrant input into the registered information input unit 130, and stores the encrypted biometric information X (referred to as Enc(X)) in the concealed information storage unit 150. The concealing unit 140 encrypts the biometric information X of the registrant with the public key pk stored in the key storage unit 120.

The random number generation unit 160 generates a random number. The generated random number is input into the information generation unit 170 and the response computation unit 190.

The information generation unit 170 generates generation source information which is information used to generate a challenge. As described above, the challenge response method is implemented in the collation system 10 of the present exemplary embodiment. That is, the server 200 sends a challenge to the client 100. Then, the client 100 sends contents corresponding to the sent challenge to the server 200 as a response.

However, when the normal challenge response method, which generally initiates the challenge from the server side, is implemented, there is a problem that an attacker can forge the response. The reason is that in the normal challenge response method, an attacker may be able to generate a new response by removing the previous challenge from the response on previous authentication and embedding the new challenge into the response on previous authentication. The normal challenge response method is implemented, in the collation system described in PTL 1 and the authentication device described in PTL 2, for example.

The information generation unit 170 of the present exemplary embodiment generates the generation source information using the public key pk, on the basis of the generated random number and the template (i.e., Enc(X) obtained by encrypting the biometric information X of the registrant). Next, the information generation unit 170 sends the generated generation source information to the server 200. Unlike the normal challenge response method, in the challenge response method of the present exemplary embodiment, the server 200 generates a challenge on the basis of the sent generation source information.

The information input for collation against the registered information is referred to as collation information. The collation information input unit 180 receives input of collation information. In the present exemplary embodiment, the biometric information of the authenticated person is input into the collation information input unit 180 as the collation information. As mentioned above, the registered information and the collation information are represented by vectors of a common dimension.

The collation information input unit 180 may be an input device depending on the collation information. For example, when biometric information extracted from a fingerprint is used as the collation information, the collation information input unit 180 may be an input device that reads the fingerprint, extracts a vector that serves as the collation information from the fingerprint, and accepts input of the vector. The collation information input unit 180 may also be an input device into which a vector that serve as collation information is input directly. In addition, the registered information input unit 130 and the collation information input unit 180 may be a common input device.

The vector corresponding to the biometric information (collation information) of the authenticated person that is input into the collation information input unit 180 is denoted by Y.

The response computation unit 190 computes the response using the public key pk on the basis of the random number included in the generation source information, the biometric information Y of the authenticated person, and the challenge sent from the server 200. The random number included in the generation source information is the information related to the replay attack. Therefore, if the random number included in the generation source information is not obtained, for example, a replay attack becomes impossible.

In order to obtain the random number included in the generation source information, the secret key managed by the server 200 is required. The secret key corresponds to the public key pk. However, it is difficult for an attacker to steal the secret key. Therefore, the challenge response method implemented in the collation system 10 of the present exemplary embodiment is more resistant to spoofing than the normal challenge response method described above.

The computed response includes an index, which is a value indicating the closeness between the biometric information X and the biometric information Y In addition, the computed response itself is encrypted. In this case, the response computation unit 190 computes the response without decrypting the template Enc(X). The response computation unit 190 sends the computed response to the server 200.

The output unit 191 receives the authentication result information indicating the result of the biometric authentication sent from the server 200. The output unit 191 outputs the received authentication result information to the outside of the client 100.

The key receiving unit 110, the information generation unit 170, the response computation unit 190, and the output unit 191 are realized, for example, by a CPU (Central Processing Unit) of a computer that operates according to a program for the client and a communication interface of the computer. For example, the CPU may read the program for the client from a program recording medium such as a program storage device of the computer, and operate as the key receiving unit 110, the information generation unit 170, the response computation unit 190, and the output unit 191 according to the program and using the communication interface. The concealing unit 140 and the random number generation unit 160 are realized, for example, by the CPU of a computer that operates according to a program for the client. For example, the CPU may read the program for the client from the program recording medium as described above, and operate as the concealing unit 140 and the random number generation unit 160 according to the program.

The key storage unit 120 and the concealed information storage unit 150 are realized, for example, by a storage device which the computer comprises.

As shown in FIG. 1, the server 200 comprises a key generation unit 210, a key storage unit 220, a key sending unit 230, a random number generation unit 240, a challenge generation unit 250, an acceptance range storage unit 260, and a determination unit 270.

The key generation unit 210 generates a secret key and the aforementioned public key pk. Hereinafter, this secret key is referred to as sk. Biometric information is not input to the server 200. Therefore, the key generation unit 210 generates the public key pk and the secret key sk without relying on the biometric information X (in other words, without using the biometric information X).

The key generation unit 210 generates the public key pk and the secret key sk using a parameter (called the security parameter) that indicates the strength of the key. This operation can be shown as follows, assuming that the security parameter is κ.

KeyGen (1^{κ})→(pk, sk)

The fact that c is the ciphertext, which is generated by encrypting the plaintext message m with the public key pk, can be shown as follows.

Enc(pk, m)→c

The ciphertext is decrypted by the secret key sk. This can be shown as follows.

Dec(sk, c)→m

When the key generation unit 210 generates the public key pk and the secret key sk, it stores the public key pk and the secret key sk in the key storage unit 220.

The key storage unit 220 is a storage device that stores the public key pk and the secret key sk.

The key sending unit 230 sends the public key pk generated by the key generation unit 210 to the client 100. The secret key sk is not sent to the client 100.

In the present exemplary embodiment, the case is explained as an example where the key generation unit 210 generates a set of public key pk and the secret key sk, and the key sending unit 230 sends the same public key pk to each client 100.

The public key pk sent by the key sending unit 230 to client 100 is received at the key receiving unit 110 of client 100 and stored in the key storage unit 120 of client 100.

The random number generation unit 240 generates a random number. The generated random number is input into the challenge generation unit 250 and the determination unit 270.

The challenge generation unit 250 generates a challenge using the secret key sk or the public key pk, on the basis of the input random number and the generation source information sent by the information generation unit 170. The challenge generation unit 250 sends the generated challenge to the client 100.

The determination unit 270 determines whether the received response is a response corresponding to the sent challenge or not, using the secret key sk stored in the key storage unit 220. As an example of the determination, the determination unit 270 determines whether the received response can be decrypted by the secret key sk or not. It is noted that decryption can be said to be cancellation of the concealment.

When the received response corresponds to the sent challenge, the determination unit 270 determines whether the index included in the decrypted response is a value within the predetermined acceptance range or not, using an input random number. By determining whether the index is a value within the acceptance range or not, the determination unit 270 determines whether the biometric information X and the biometric information Y match or not (in other words, whether the registrant and the authenticated person match or not). The determination unit 270 uses the acceptance range stored in the acceptance range storage unit 260 for the determination.

Therefore, if the index included in the response is a value within the acceptance range, the determination unit 270 determines that the biometric information X and the biometric information Y match (in other words, the authenticated person corresponds to the registrant). If the index included in the response is not a value within the acceptance range, the determination unit 270 determines that the biometric information X and the biometric information Y do not match (in other words, the authenticated person does not correspond to the registrant).

As described above, the determination unit 270 determines whether biometric information X and the biometric information Y match or not, according to whether the index included in the response is a value within the acceptance range or not. Therefore, even if the biometric information X and the biometric information Y do not match perfectly (even if there is a gap that does not cause problems), if the index is a value within the acceptance range, the determination unit 270 can determine that the biometric information X and the biometric information Y match. The process of using the acceptance range is an example of a process to determine that biometric information X and the biometric information Y match even if there is a gap that does not cause problems.

When the biometric information X and the biometric information Y match, the authentication is considered successful, and the post-authentication process can be executed. For example, as an example, the server 200 may send the determination result of the determination unit 270 to the client 100, and when the client 100 receives the determination result that the biometric information X and the biometric information Y match, the client 100 may assume that the authentication was successful and execute the post-authentication process. However, the device that performs the post-authentication process is not limited to the client 100. Any device other than the client 100 may perform the post-authentication process on the condition that the determination result that the biometric information X and the biometric information Y match is obtained.

The key sending unit 230, the challenge generation unit 250, and the determination unit 270 are realized, for example, by a CPU of a computer that operates according to a program for the server and a communication interface of the computer. For example, the CPU may read the program for the server from a program recording medium such as a program storage device of the computer, and operate as the key sending unit 230, the challenge generation unit 250, and the determination unit 270 using the communication interface in accordance with the program. The key generation unit 210 and the random number generation unit 240 are realized, for example, by the CPU of a computer operating in accordance with the program for the server. For example, the CPU can read the program for the server from the program recording medium as described above, and operate as the key generation unit 210 and the random number generation unit 240 according to the program.

The key storage unit 220 and the acceptance range storage unit 260 are realized, for example, by a storage device which the computer comprises.

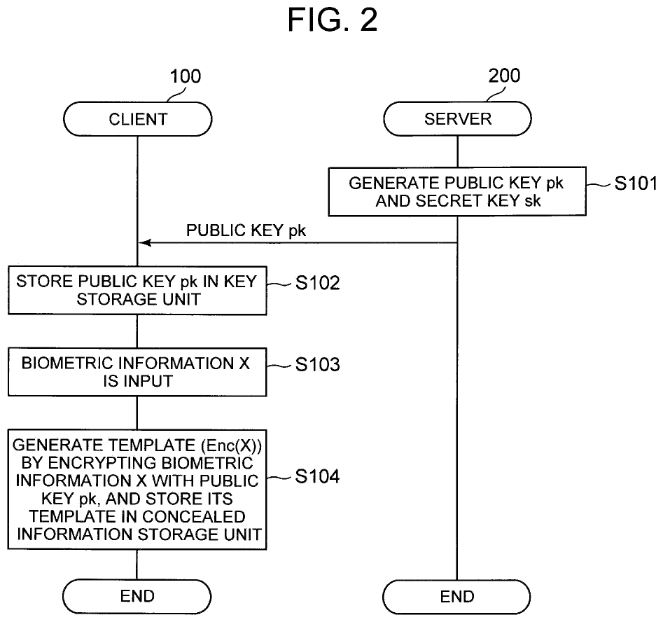

Next, the processing will be explained. FIG. 2 is a flowchart showing an example of processing when storing a template in advance in the concealed information storage unit 150 of the client 100. The detailed explanation is omitted for the matters already explained.

First, the key generation unit 210 of the server 200 generates the public key pk and the secret key sk (step S101). At this time, the key generation unit 210 generates the public key pk and the secret key sk without using the biometric information X. In addition, the key generation unit 210 stores the generated public key pk and the secret key sk in the key storage unit 220.

Next, the key sending unit 230 sends the public key pk generated in step S101 to the client 100. Then, the key receiving unit 110 of the client 100 receives the public key pk from the server 200. The key receiving unit 110 stores the public key pk in the key storage unit 120 (step S102).

Then, the biometric information X of the registrant is input into the registered information input unit 130 (step S103). Then, the concealing unit 140 generates a template (Enc(X)) by encrypting the biometric information X with the public key pk stored in the key storage unit 120, and stores the template in the concealed information storage unit 150 (step S104).

The above processing described referring to in FIG. 2 may be repeated. The processing of storing the template in advance is not limited to the example shown in FIG. 2. For example, step S103 may be performed before step S101.

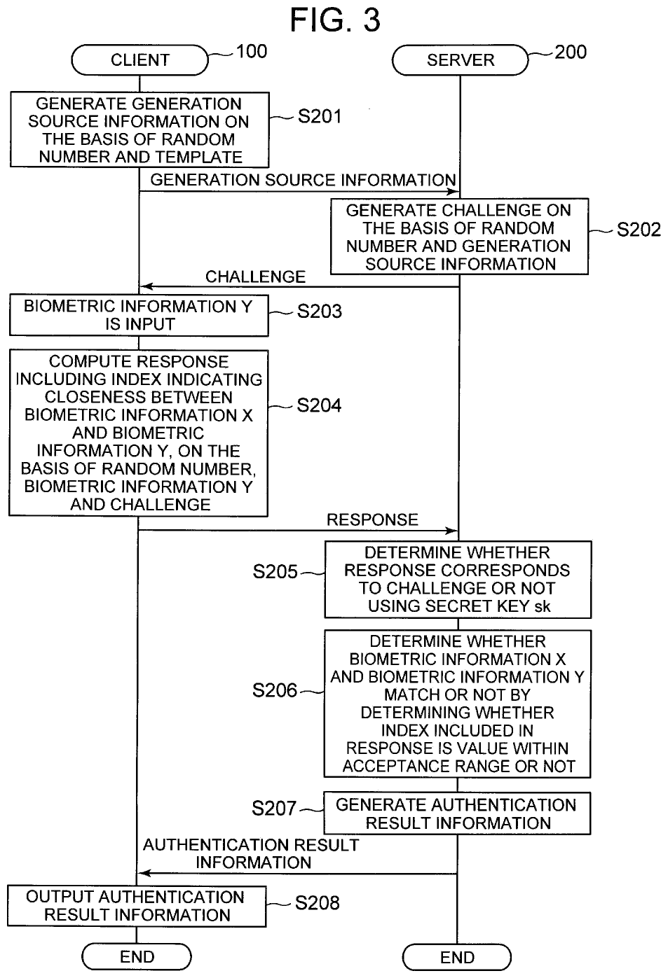

FIG. 3 is a flowchart showing an example of processing when authentication is performed. The detailed explanation is omitted for the matters already explained.

First, the information generation unit 170 generates the generation source information using the public key pk stored in the key storage unit 120, on the basis of the random number generated by the random number generation unit 160 and the template (step S201). Next, the information generation unit 170 sends the generated generation source information to the server 200.

The challenge generation unit 250 receives the sent generation source information. Next, the challenge generation unit 250 generates a challenge using the secret key sk or the public key pk stored in the key storage unit 220, on the basis of the random number generated by the random number generation unit 240 and the received generation source information (step S202). Next, the challenge generation unit 250 sends the generated challenge to the client 100.

Next, the biometric information Y of the authenticated person is input into the collation information input unit 180 (step S203).

Next, the response computation unit 190 computes a response including an index indicating closeness between the biometric information X and the biometric information Y, on the basis of the random number generated by the random number generation unit 160, the biometric information Y input in step S203, and the received challenge, using the public key pk (step S204).

Next, the response computation unit 190 sends the response computed in step S204 to the server 200. Then, the determination unit 270 of the server 200 receives the response sent from the client 100.

Next, the determination unit 270 determines whether the received response is a response corresponding to the sent challenge or not, using the secret key sk (step S205).

When the received response corresponds to the sent challenge, the determination unit 270 determines whether the biometric information X and the biometric information Y match or not by determining whether the index included in the response is a value within a predetermined acceptance range or not (step S206). When the received response does not correspond to the sent challenge, the determination unit 270 need not perform the processing of step S206.

When the index included in the response is a value within the acceptance range, the determination unit 270 generates authentication result information indicating “authentication success” as the biometric information X and the biometric information Y match. When the received response does not correspond to the sent challenge, or when the index included in the response is not a value within the acceptance range, the determination unit 270 generates authentication result information indicating “authentication failure” as the biometric information X and the biometric information Y do not match (step S207).

Next, the determination unit 270 sends the generated authentication result information to the client 100. Then, the output unit 191 of the client 100 receives the authentication result information sent from the server 200. Next, the output unit 191 outputs the received authentication result information (step S208).

The authentication result information may be output directly from the server 200. The above processing explained referring to in FIG. 3 may be repeated.

Hereinafter, each specific example of the authentication phase of the present exemplary embodiment will be explained. In the following explanation, it is assumed that both the biometric information X and the biometric information Y are n-dimensional vectors. Namely, assuming that {uᵢ} represents an n-dimensional vector (u₁, u₂, . . . , uₙ), X is expressed by (x₁, . . . , xₙ)={xᵢ} and Y is expressed by (y₁, . . . , yₙ)={yᵢ}, respectively.

In the following specific examples, the ciphertext obtained by encrypting the plaintext m with the public key pk is denoted as Enc(pk, m). When Enc(pk, m) is further expressed by another symbol (for example, c), it is written as Enc(pk, m)→c. In the following explanation, x, y and z are assumed to be plaintexts.

### Specific Example 1

In this specific example, the case where the concealing unit 140 encrypts the biometric information X of the registrant using a cryptosystem with additive homomorphism is explained as an example. Therefore, in this example, the public key pk is a public key in a public key cryptosystem with additive homomorphism. Any cryptosystem with additive homomorphism can be used as an available cryptosystem.

The following is an explanation of a characteristic of cryptosystem with additive homomorphism. In the cryptosystem with additive homomorphism, the ciphertext Enc(pk, x+y) of x+y can be computed from the ciphertext c₁ of x by public key pk (i.e., Enc(pk, x)→c₁) and the ciphertext c₂ of y by public key pk (i.e., Enc(pk, y)→c₂). In the following, this operation is expressed as follows.

⊕ [Math. 1]

Therefore, the following equation (1) is completed.

[Math. 2]

c₁⊕c₂=Enc(pk,x+y) (1)

By repeating the above operation, it is possible to compute the ciphertext of x·z (i.e., Enc(pk, x·z)) from the ciphertext c₁ of x by public key pk (i.e., Enc(pk, x)→c₁) and z. In the following, this operation is expressed as follows.

⊙ [Math. 3]

In other words, the following equation (2) is completed.

[Math. 4]

c₁⊙z=Enc(pk,x·z) (2)

In this specific example, the concealed information storage unit 150 stores Enc(X), which is obtained by encrypting the biometric information X of the registrant by the public key pk in the public key cryptosystem with additive homomorphism, as a template. The registration process from the generation of the public key pk and the secret key sk to the storage of the template is performed according to the flowchart shown in FIG. 2.

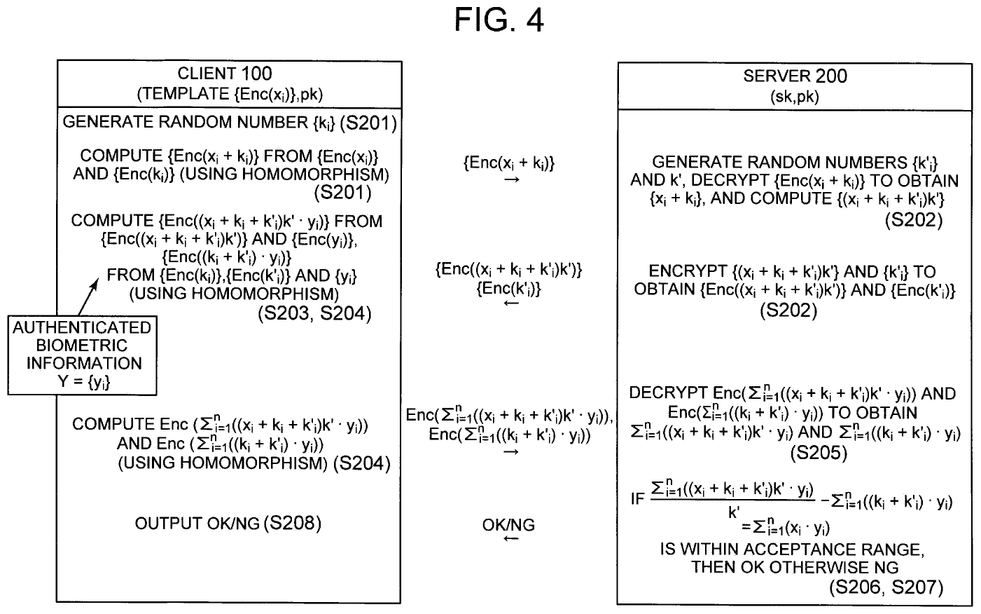

The following explains the specific authentication process when a cryptosystem with additive homomorphism is used, referring to FIG. 4. FIG. 4 is an explanatory diagram showing an example of the specific authentication process in the collation system 10. Each step number, such as S201 shown in FIG. 4, corresponds to each step number shown in FIG. 3.

First, the random number generation unit 160 generates a random number (step S201). The random number generation unit 160 inputs the generated random number to the information generation unit 170.

Next, the information generation unit 170 obtains {Enc(kᵢ)} by encrypting the random number {kᵢ} with the public key pk. Next, the information generation unit 170 computes {Enc(xᵢ+kᵢ)} from the templates {Enc(xᵢ)} and {Enc(kᵢ)} using homomorphism (step S201). The reason for masking (hiding) the template with a random number is that the biometric information X is not acquired from the server 200.

Next, the information generation unit 170 sends the computed {Enc(xᵢ+kᵢ)} to the server 200 as the generation source information. The challenge generation unit 250 receives the sent {Enc(xᵢ+kᵢ)}.

Next, the random number generation unit 240 generates the random number {k′ᵢ} and the random number k′, respectively. The random number generation unit 240 inputs the generated random number {k′ᵢ} and the random number k′ to the challenge generation unit 250.

Next, the challenge generation unit 250 decrypts the received {Enc(xᵢ+kᵢ)} with the secret key sk to obtain {xᵢ+kᵢ}. After decryption, the challenge generation unit 250 computes {(xᵢ+kᵢ+k′ᵢ)k′} using the input random number (step S202).

Next, the challenge generation unit 250 encrypts the computed {(xᵢ+kᵢ+k′ᵢ)k′} and {k′ᵢ} with the public key pk, respectively to obtain {Enc((xᵢ+kᵢ+k′ᵢ)k′)} and {Enc(k′ᵢ)} (step S202).

Next, the challenge generation unit 250 sends the obtained {Enc((xᵢ+kᵢ+k′ᵢ)k′)} and {Enc(k′ᵢ)} to the client 100 as a challenge. The response computation unit 190 receives the sent challenge.

Next, the biometric information Y={yᵢ} of the authenticated person is input into the collation information input unit 180 (step S203).

Next, the response computation unit 190 computes {Enc((xᵢ+kᵢ+k′ᵢ)k′·yᵢ)} using homomorphism from {Enc((xᵢ+kᵢ+k′ᵢ)k′)} included in the challenge and the biometric information {yᵢ}. The response computation unit 190 also computes {Enc((kᵢ+k′ᵢ)·yᵢ)} using homomorphism from {Enc(kᵢ)} used in step S201, {Enc(k′ᵢ)} included in the challenge, and biometric information {yᵢ} (step S204).

Next, the response computation unit 190 computes Enc(Σⁿᵢ₌₁((xᵢ+kᵢ+k′ᵢ)k′·yᵢ)) using homomorphism, on the basis of {Enc((xᵢ+kᵢ+k′ᵢ)k′·yᵢ)}. The response computation unit 190 also computes Enc(Σⁿᵢ₌₁((kᵢ+k′ᵢ)·yᵢ)) using homomorphism, on the basis of {Enc((kᵢ+k′ᵢ)·yᵢ)}.

Next, the response computation unit 190 sends the computed Enc(Σⁿᵢ₌₁((xᵢ+kᵢ+k′ᵢ)k′·yᵢ)) and Enc(Σⁿᵢ₌₁((kᵢ+k′ᵢ)·yᵢ)) as a computed response to the server 200. The determination unit 270 receives the sent response.

Next, the determination unit 270 obtains Σⁿᵢ₌₁((xᵢ+kᵢ+k′ᵢ)k′·yᵢ) by decrypting Enc(Σⁿᵢ₌₁((xᵢ+kᵢ+k′ᵢ)k′·yᵢ)) included in the received response with the secret key sk. The determination unit 270 also obtains Σⁿᵢ₌₁((kᵢ+k′ᵢ)·yᵢ) by decrypting Enc(Σⁿᵢ₌₁((kᵢ+k′ᵢ)·yᵢ)) included in the received response with the secret key sk (step S205). When each value is decrypted with the secret key sk, it can be seen that the received response corresponds to a ciphertext encrypted with the public key pk corresponding to the secret key sk.

Next, the determination unit 270 performs the following computation using each value obtained in step S205 and the random number k′ used in step S202.

$${\sum }_{i = 1}^{n} ( ( {x}_{i} + {k}_{i} + {k}_{i}^{′} ) {k}^{′} \cdot {y}_{i} ) / {k}^{′} - {\sum }_{i = 1}^{n} ( ( {k}_{i} + {k}_{i}^{′} ) \cdot {y}_{i} ) = {\sum }_{i = 1}^{n} ( {x}_{i} \cdot {y}_{i} ) \qquad ( 3 )$$

Therefore, if the received response corresponds to the sent challenge, the determination unit 270 can correctly compute the inner product value of {xᵢ} and {yᵢ}. The determination unit 270 determines whether Σⁿᵢ₌₁(xᵢ·yᵢ) obtained by the computation of equation (3) is a value within the acceptance range stored in the acceptance range storage unit 260 or not (step S206). When Σⁿᵢ₌₁(xᵢ·yᵢ) is a value within the acceptance range, the determination unit 270 generates the authentication result information indicating “Authentication success (OK shown in FIG. 4). When Σⁿᵢ₌₁(xᵢ·yᵢ) is not a value within the acceptance range, the determination unit 270 generates the authentication result information indicating “Authentication failure (NG shown in FIG. 4)” (step S207).

Next, the determination unit 270 sends the generated authentication result information to the client 100. Next, the output unit 191 receives the transmitted authentication result information. The output unit 191 outputs the received authentication result information (step S208). It is noted that the authentication result information may be output directly from the server 200.

### Specific Example 2

In this specific example, as an example of a public key cryptosystem with additive homomorphism, the additive homomorphism ElGamal encryption is used. In the following, suppose a group G such that the order is q. The generation source of the group G is regarded as g.

In additive homomorphism ElGamal encryption, a set of a secret key sk and a public key pk=g^{sk} is generated. Note that sk∈Z_{q} (Z is a symbol for the set of whole integers). Z_{q} is a set of {1, . . . , q−1}. The group G, the order q, and the generation source g are shared between the client 100 and the server 200.

In the additive homomorphism ElGamal encryption, the ciphertext c of x with a public key pk (i.e., Enc(pk, x)→c) is denoted as c=(g^{r}, g^{x}·g^{r·sk}). Note that x∈Z_{q} is an integer and r∈Z_{q} is a random number. In addition, the ciphertext c in this specific example is a vector.

In this specific example, the concealed information storage unit 150 stores {cᵢ}, which is obtained by encrypting the biometric information X of the registrant with the public key pk in the additive homomorphism ElGamal encryption, as a template. The registration process from the generation of the public key pk and the secret key sk to the storage of the template is performed according to the flowchart shown in FIG. 2.

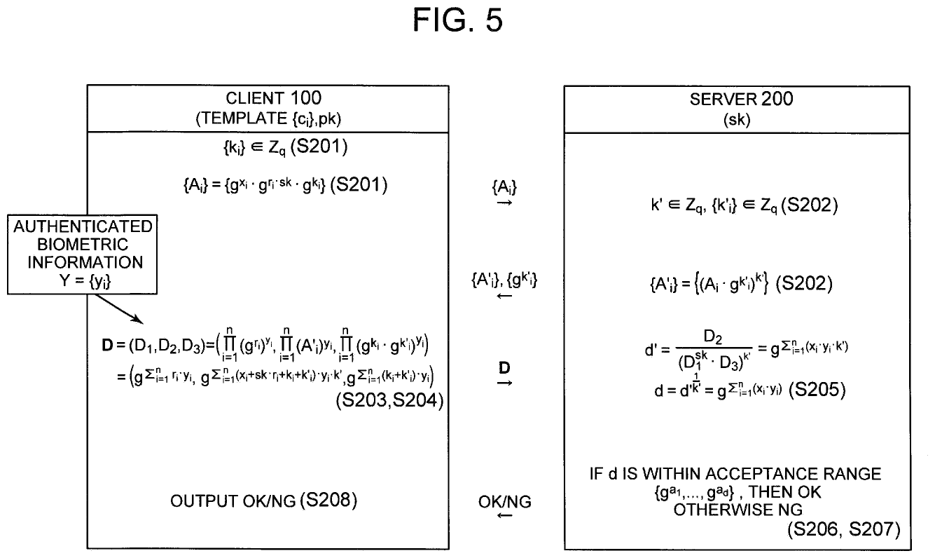

Hereinafter, the specific authentication process when the additive homomorphism ElGamal encryption is used is explained referring to FIG. 5. FIG. 5 is an explanatory diagram showing another example of the specific authentication process in the collation system 10. Each step number, such as S201 shown in FIG. 5, corresponds to each step number shown in FIG. 3.

First, the random number generation unit 160 randomly generates kᵢ ∈Z_{q}=(i=1, 2, . . . , n) (step S201). The random number generation unit 160 inputs the generated random number {kᵢ} to the information generation unit 170.

Next, the information generation unit 170 computes {Aᵢ}={g^{xi}·g^{ri·sk}·g^{ki}} from the template {cᵢ} and the random number {kᵢ} (step S201). The reason for masking (hiding) the template with a random number is to reduce the possibility of the biometric information X is acquired from the server 200.

Next, the information generation unit 170 sends the computed {Aᵢ} to the server 200 as the generation source information. The challenge generation unit 250 receives the transmitted {Aᵢ}.

Next, the random number generation unit 240 randomly generates k′∈Z_{q} and k′ᵢ ∈Z_{q}=(i=1, 2, . . . , n), respectively (step S202). The random number generation unit 240 inputs the generated random number k′ and the random number {k′ᵢ} to the challenge generation unit 250.

Next, the challenge generation unit 250 computes {A′ᵢ}={(Aᵢ·g^{k′i})^{k′}} from the received {Aᵢ} and the input random number (step S202).

Next, the challenge generation unit 250 sends the obtained {A′ᵢ} and to the client 100 as a challenge. The response computation unit 190 receives the sent challenge.

Next, the biometric information Y={yᵢ} of the authenticated person is input into the collation information input unit 180 (step S203). The response computation unit 190 computes the response D as follows (step S204).

$$D = ( {D}_{1} , {D}_{2} , {D}_{3} ) = ( {\prod }_{i = 1}^{n} {( {g}^{{r}_{i}} )}^{{y}_{i}} , {\prod }_{i = 1}^{n} {( {A}_{i}^{'} )}^{{y}_{i}} , {\prod }_{i = 1}^{n} {( {g}^{{k}_{i}} \cdot {g}^{{k}_{i}^{'}} )}^{{y}_{i}} ) = ( {g}^{{\sum }_{i = 1}^{n} {r}_{i} \cdot {y}_{i}} , {g}^{{\sum }_{i = 1}^{n} ( {x}_{i} + sk \cdot {r}_{i} + {k}_{i} + {k}_{i}^{'} ) \cdot {y}_{i} \cdot {k}^{′}} , {g}^{{\sum }_{i = 1}^{n} ( {k}_{i} + {k}_{i}^{′} ) \cdot {y}_{i}} , ) \qquad [ Math . 5 ]$$

The computed response D represents the distance to the challenge. The response D is a vector. Next, the response computation unit 190 sends the computed response D to the server 200. The determination unit 270 receives the sent response D.

Next, the determination unit 270 determines whether the response D deals with the challenge using the secret key sk or not by checking whether the following computation can be performed or not (step S205). In the following computation, the shift for the challenge is corrected.

$${d}^{′} = \frac{{D}_{2}}{{( {D}_{1}^{s k} \cdot {D}_{3} )}^{{k}^{′}}} = {g}^{{\sum }_{i = 1}^{n} ( {x}_{i} \cdot {y}_{i} \cdot {k}^{′} )} \\ d = {d}^{′ \frac{1}{{k}^{′}}} = {g}^{{\sum }_{i = 1}^{n} ( {x}_{i} \cdot {y}_{i} )} \qquad [ Math . 6 ]$$

Next, the determination unit 270 determines whether d obtained in step S205 is a value within the acceptance range {g^{a1}, . . . , g^{an}} or not (step S206). Note that {aᵢ}=a₁, a₂, . . . , aₙ represents all the values included in the acceptance range. The {aᵢ} itself need not be stored in the acceptance range storage unit 260.

When d is a value within the acceptance range, the determination unit 270 generates the authentication result information indicating “authentication success (OK shown in FIG. 5). When d is not a value within the acceptance range, the determination unit 270 generates the authentication result information indicating “authentication failure (NG shown in FIG. 5)” (step S207).

Next, the determination unit 270 sends the generated authentication result information to the client 100. Next, the output unit 191 receives the transmitted authentication result information. The output unit 191 outputs the received authentication result information (step S208). The authentication result information may be output directly from the server 200.

This specific example has the advantage that the communication amount between the client 100 and the server 200 is reduced. For example, for the sake of comparison, assume an additive homomorphism ElGamal encryption as the additive homomorphism cipher used in specific example 1.

The generation source information in specific example 1, {Enc(xᵢ+kᵢ)} is composed of 2n elements {g^{ri}, g^{x}·g^{ri·sk}} of group G. In addition, {Aᵢ}, which is the generation source information in specific example 2, is composed of the n elements {g^{xi}·g^{ri·sk}·g^{ki}} of group G. The number of elements that make up each challenge is also the same.

Therefore, the communication amount between the client 100 and the server 200 regarding the generation source information and the challenge is 4n in specific example 1 and 2n in specific example 2. As described above, the communication amount in this specific example is smaller than that in specific example 1.

[Description of Effects]

As mentioned above, the template stored in the client is not subject to protection under the personal information protection law. However, the biometric information is personal information that will never change in a lifetime.

Even if biometric information is stored only in the client as a template for use in a service provided by a certain business, the manager of the business may be pursued liability if the biometric information is leaked.

In addition, there is a danger that biometric information may be leaked from the client, for example, if the client is infected with malware. However, this danger is difficult to eliminate through the efforts of service providers.

In FIDO, information, that the biometric information of the registrant is encrypted, is stored in the client as a template. However, when the biometric information of the registrant is input, the client decrypts the template with a key. At this time, there is a possibility that the biometric information decrypted from the template will be leaked. In addition, even if the template is not decrypted, when the template and the key are stolen together by a third party, the third party can obtain the biometric information by decrypting the template.

In addition, an IC chip of a cash card has tamper-resistant. However, when biometric authentication is performed outside the IC chip, if the encrypted biometric information stored in the IC chip is decrypted and transmitted outside the IC chip, there is a possibility that the decrypted biometric information will be leaked.

According to the present exemplary embodiment, the key generation unit 210 of the server 200 generates the public key pk and the secret key sk without using the biometric information X. Then, the key receiving unit 110 of the client 100 receives the public key pk from the server 200 and stores it in the key storage unit 120 of the client 100. When the biometric information X is input to the client 100, the concealing unit 140 generates a template by encrypting the biometric information X using the public key pk generated without using the biometric information X, and stores the template in the concealed information storage unit 150 of the client 100. Therefore, according to the present exemplary embodiment, the template can be stored in the client 100. Since the template is encrypted, leakage of the biometric information X or part of X from the template can be prevented. Furthermore, even if the template and the public key pk are stolen together from the client 100, leakage of the biometric information X or part of X can be prevented because data included in the template is not be able to be decrypted by the public key pk. In addition, since server 200 does not receive the biometric information X at the stage of template registration on the client 100 side, leakage of the biometric information X or part of X from server 200 can also be prevented.

At the time of authentication, the information generation unit 170 first generates the generation source information which is the information used to generate the challenge. Then, the challenge generation unit 250 generates a challenge on the basis of the generation source information. Next, the response computation unit 190 computes a response that includes an index indicating the closeness between the biometric information X and the biometric information Y, on the basis of the input biometric information Y and the received challenge.

Next, the determination unit 270 determines whether the received response is the response corresponding to the sent challenge or not using the secret key sk stored in the key storage unit 220. When the received response corresponds to the sent challenge, the determination unit 270 determines whether the biometric information X and the biometric information Y match or not by determining whether the index included in the response is a value within the acceptance range or not.

Since the collation system 10 of the present exemplary embodiment performs authentication using a challenge response method, the value of the response is changed for each authentication. Therefore, even if an attacker wiretaps the value of the response, a replay attack is prevented because the wiretapped value can no longer be used in the next authentication.

In addition, when the process in which the challenge is sent from the server 200 is the first process, as in the normal challenge response method, there is a possibility of generating a response at the time the spoofing is requested, on the basis of the challenge and response at any time and the challenge at the time the spoofing is requested.

In the present exemplary embodiment, the generation source information in which a challenge in the normal challenge response method is embedded is called the challenge, so that the attacker is not aware of it. Therefore, the attacker cannot execute the above attack because the attacker cannot know the challenge in the normal challenge response method. Accordingly, the collation system 10 of the present exemplary embodiment is more resistant to spoofing than a collation system in which the normal challenge response method is implemented.

In the exemplary embodiment of the present invention and its specific example, the acceptance range stored in the acceptance range storage unit 260 may be changed for each user or for each client. The acceptance range may also be changed according to external factors or the like. Examples of external factors include the frequency of authentication received by the server 200, the frequency of suspicious accesses, the state of the communication network and CPU load, and so on. If the acceptance range is changed, the load on the communication network and CPU may be reduced.

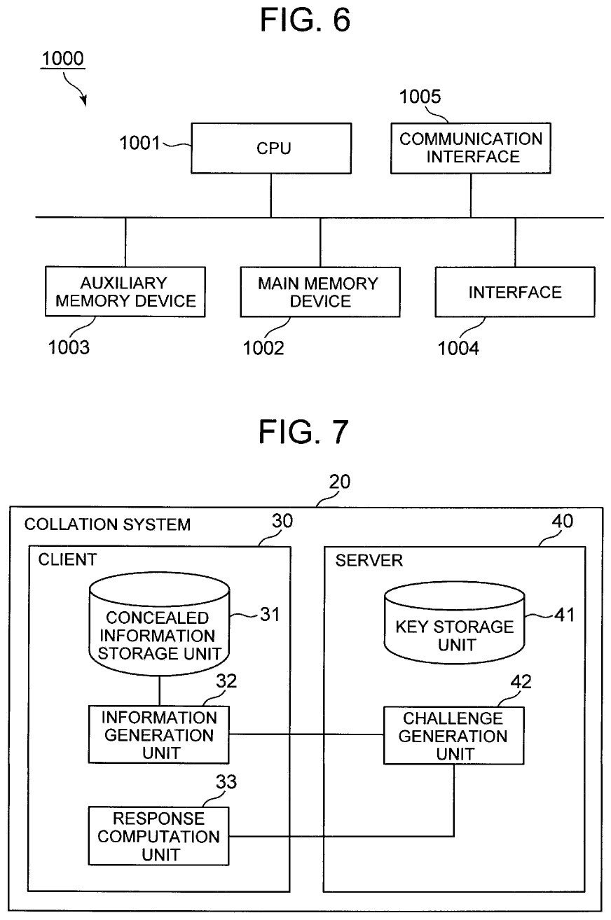

FIG. 6 is a schematic block diagram showing a configuration example of a computer for each of the client 100 and the server 200 in aforementioned exemplary embodiment or its specific example. As is explained below with reference to FIG. 6, the computer used as the client 100 and the computer used as the server 200 are separate computers.

The computer 1000 has a CPU 1001, a main memory device 1002, an auxiliary memory device 1003, an interface 1004, and a communication interface 1005.

The client 100 and the server 200 in the exemplary embodiment of the present invention and its specific example are realized by a computer 1000. However, as described above, the computer used as the client 100 and the computer used as the server 200 are separate computers.

The operation of the computer 1000 that realizes the client 100 is stored in the auxiliary memory device 1003 in the form of a program for the client. The CPU 1001 reads the program for the client from the auxiliary memory device 1003, expands it to the main memory device 1002, and executes the operation of the client 100 described in the above exemplary embodiment and its specific example according to the program for the client.

The operation of the computer 1000 that realizes the server 200 is stored in the auxiliary memory device 1003 in the form of a program for the server. The CPU 1001 reads the program for the server from the auxiliary memory device 1003, expands it to the main memory device 1002, and executes the operation of the server 200 described in the above exemplary embodiment and its specific example according to the program for the server.

The auxiliary memory device 1003 is an example of a non-transitory tangible medium. Other examples of non-transitory tangible media are a magnetic disk, an optical magnetic disk, a CD-ROM (Compact Disk Read Only Memory), a DVD-ROM (Digital Versatile Disk Read Only Memory), a semiconductor memory, and the like, which are connected via the interface 1004. When the program is delivered to the computer 1000 via a communication line, the computer 1000 that receives the delivery may expand the program into the main memory device 1002 and operate according to the program.

Some or all of the components of the client 100 may be realized by general-purpose or dedicated circuitry, processors, or a combination of these. They may be configured by a single chip or by multiple chips connected via a bus. Some or all of the components may be realized by a combination of the above-mentioned circuits, etc. and a program. The configures are also true for the server 200.

Next, an outline of the present invention is described. FIG. 7 is a block diagram showing an outline of a collation system according to the present invention. The collation system 20 according to the present invention is a collation system which employs a challenge response method, comprising a client 30 (for example, the client 100) and a server 40 (for example, the server 200), wherein the client 30 comprises a concealed information storage unit 31 (for example, the concealed information storage unit 150) which stores concealed information obtained by concealing registered information by use of a public key, an information generation unit 32 (for example, the information generation unit 170) which, on the basis of the concealed information and a random number, generates, by use of the public key, generation source information that is information for generating a challenge, and a response computation unit 33 (for example, the response computation unit 190) which, by use of the challenge sent from the server, collation information to be collated against the registered information, and the random number, computes a response corresponding to the challenge, and wherein the server 40 comprises a key storage unit 41 (for example, the key storage unit 220) which stores a secret key corresponding to the public key, and a challenge generation unit 42 (for example, the challenge generation unit 250) which generates the challenge on the basis of the generation source information sent from the client.

With such a configuration, the collation system can prevent replay attacks in the authentication process.

The server 40 may comprise a determination unit (for example, the determination unit 270) may determine, by use of the secret key whether the response sent from the client corresponds to the challenge or not. The determination unit may determine whether the collation information and the registered information match or not, on the basis of an index, which is included in the response corresponding to the challenge, indicating closeness between the registered information and the collation information. The registered information and the collation information may be expressed by vectors.

With such a configuration, the collation system can determine whether the collation information and the registered information match or not.

The client 30 may comprise a concealing unit (for example, the concealing unit 140) which generates the concealed information by concealing input registered information with the public key, and stores the concealed information to the concealed information storage unit 31. The server 40 may comprise a key generation unit (for example, the key generation unit 210) which generates the secret key and the public key, and a key sending unit (for example, the key sending unit 230) which sends the public key to the client 30. The secret key and the public key may be those in a public key cryptosystem with additive homomorphism. The public key cryptosystem may also be an additive homomorphism ElGamal encryption.

With such a configuration, the collation system can encrypt the registered information with a public key cryptosystem.

The aforementioned exemplary embodiment of the present invention can be described as supplementary notes mentioned below, but are not limited to the following supplementary notes.

(Supplementary Note 1)

A collation system which employs a challenge response method, comprising a client and a server,

wherein the client comprises:

a concealed information storage unit which stores concealed information obtained by concealing registered information by use of a public key,

an information generation unit which, on the basis of the concealed information and a random number, generates, by use of the public key, generation source information that is information for generating a challenge, and

a response computation unit which, by use of the challenge sent from the server, collation information to be collated against the registered information, and the random number, computes a response corresponding to the challenge, and

wherein the server comprises:

a key storage unit which stores a secret key corresponding to the public key, and

a challenge generation unit which generates the challenge on the basis of the generation source information sent from the client.

(Supplementary Note 2)

The collation system according to Supplementary note 1, wherein

the server comprises a determination unit which determines, by use of the secret key whether the response sent from the client corresponds to the challenge or not.

(Supplementary Note 3)

The collation system according to Supplementary note 2, wherein

the determination unit determines whether the collation information and the registered information match or not, on the basis of an index, which is included in the response corresponding to the challenge, indicating closeness between the registered information and the collation information.

(Supplementary Note 4)

The collation system according to any one of Supplementary notes 1 to 3, wherein

the registered information and the collation information are expressed by vectors.

(Supplementary Note 5)

The collation system according to any one of Supplementary notes 1 to 4, wherein

the client comprises a concealing unit which generates the concealed information by concealing input registered information with the public key, and stores the concealed information to the concealed information storage unit.

(Supplementary Note 6)

The collation system according to any one of Supplementary notes 1 to 5, wherein

the server comprises:

a key generation unit which generates the secret key and the public key, and

a key sending unit which sends the public key to the client.

(Supplementary Note 7)

The collation system according to any one of Supplementary notes 1 to 6, wherein

the secret key and the public key are those in a public key cryptosystem with additive homomorphism.

(Supplementary Note 8)

The collation system according to Supplementary note 7, wherein

the public key cryptosystem is an additive homomorphism ElGamal encryption.

(Supplementary Note 9)

A client which employs a challenge response method, comprises:

a concealed information storage unit which stores concealed information obtained by concealing registered information by use of a public key,

an information generation unit which, on the basis of the concealed information and a random number, generates, by use of the public key, generation source information that is information for generating a challenge, and

a response computation unit which, by use of the challenge sent from the server which employs the challenge response method, collation information to be collated against the registered information, and the random number, computes a response corresponding to the challenge.

(Supplementary Note 10)

The client according to Supplementary note 9, comprises a concealing unit which generates the concealed information by concealing input registered information with the public key, and stores the concealed information to the concealed information storage unit.

(Supplementary Note 11)

A server which employs a challenge response method, comprises:

a key storage unit which stores a secret key corresponding to a public key had by a client which employs the challenge response method, and

a challenge generation unit which generates a challenge on the basis of generation source information that is information for generating the challenge, wherein the generation source information is generated, by use of the public key, on the basis of concealed information obtained by concealing registered information by use of the public key and a random number, and sent from the client.

(Supplementary Note 12)

The server according to Supplementary note 11, comprises a determination unit which determines, by use of the secret key, whether a response sent from the client corresponds to the challenge or not.

(Supplementary Note 13)

The server according to Supplementary note 12, wherein

the determination unit determines whether collation information and the registered information match or not, on the basis of an index, which is included in the response corresponding to the challenge, indicating closeness between the registered information and the collation information.

(Supplementary Note 14)

The server according to any one of Supplementary notes 11 to 13, comprises:

a key generation unit which generates the secret key and the public key, and

a key sending unit which sends the public key to the client.

(Supplementary Note 15)

A collation method in a collation system which employs a challenge response method, comprising a client and a server,

wherein the client

stores concealed information obtained by concealing registered information by use of a public key in a concealed information storage unit,

generates, on the basis of the concealed information and a random number, by use of the public key, generation source information that is information for generating a challenge, and

sends generated generation source information to the server,

wherein the server

stores a secret key corresponding to the public key in a key storage unit,

generates the challenge on the basis of the generation source information sent from the client, and

sends generated the challenge to the client, and

wherein the client, by use of the challenge sent from the server, collation information to be collated against the registered information, and the random number, computes a response corresponding to the challenge.

(Supplementary Note 16)

A collation method in a client which employs a challenge response method, comprising:

storing concealed information obtained by concealing registered information by use of a public key in a concealed information storage unit,

generating, on the basis of the concealed information and a random number, by use of the public key, generation source information that is information for generating a challenge, and

computing, by use of the challenge sent from the server which employs the challenge response method, collation information to be collated against the registered information, and the random number, a response corresponding to the challenge.

(Supplementary Note 17)

A collation method in a server which employs a challenge response method, comprising:

storing a secret key corresponding to a public key had by a client which employs the challenge response method in a key storage unit, and

generating a challenge on the basis of generation source information that is information for generating the challenge, wherein the generation source information is generated, by use of the public key, on the basis of concealed information obtained by concealing registered information by use of the public key and a random number, and sent from the client.

(Supplementary Note 18)

A program for a client, implemented in a computer comprising a concealed information storage unit which stores concealed information obtained by concealing registered information by use of a public key and performing as the client which employs a challenge response method, causing the computer to execute:

a generating process of generating, on the basis of the concealed information and a random number, by use of the public key, generation source information that is information for generating a challenge, and

a computation process of computing, by use of the challenge sent from the server which employs the challenge response method, collation information to be collated against the registered information, and the random number, a response corresponding to the challenge.

(Supplementary Note 19)

A program for a server, implemented in a computer comprising a key storage unit which stores a secret key corresponding to a public key had by a client which employs the challenge response method and performing as the server, causing the computer to execute:

a generating process of generating a challenge on the basis of generation source information that is information for generating the challenge, wherein the generation source information is generated, by use of the public key on the basis of concealed information obtained by concealing registered information by use of the public key and a random number, and sent from the client.

While the present invention has been explained with reference to the exemplary embodiment, the present invention is not limited to the aforementioned exemplary embodiment. Various changes understandable to those skilled in the art within the scope of the present invention can be made to the structures and details of the present invention.

### INDUSTRIAL APPLICABILITY

This invention is suitably applied to a collation system that performs authentication using a client and a server.

### REFERENCE SIGNS LIST

10, 20 Collation system
30, 100 Client
40, 200 Server
31, 150 Concealed information storage unit
32, 170 Information generation unit
33, 190 Response computation unit
41, 120, 220 Key storage unit
42, 250 Challenge generation unit
110 Key receiving unit
130 Registered information input unit
140 Concealing unit
160, 240 Random number generation unit
180 Collation information input unit
191 Output unit
210 Key generation unit
230 Key sending unit
260 Acceptance range storage unit
270 Determination unit

What is claimed is:

1. A collation system which employs a challenge response method, comprising a client and a server,
wherein the client comprises:
a concealed information storage unit which stores concealed information obtained by concealing registered information by use of a public key,
an information generation unit which, on the basis of the concealed information and a random number, generates, by use of the public key, generation source information that is information for generating a challenge, and
a response computation unit which, by use of the challenge sent from the server, collation information to be collated against the registered information, and the random number, computes a response corresponding to the challenge, and
wherein the server comprises:
a key storage unit which stores a secret key corresponding to the public key, and
a challenge generation unit which generates the challenge on the basis of the generation source information sent from the client.

2. The collation system according to claim 1, wherein
the server comprises a determination unit which determines, by use of the secret key whether the response sent from the client corresponds to the challenge or not.

3. The collation system according to claim 2, wherein
the determination unit determines whether the collation information and the registered information match or not, on the basis of an index, which is included in the response corresponding to the challenge, indicating closeness between the registered information and the collation information.

4. The collation system according to claim 1, wherein
the registered information and the collation information are expressed by vectors.

5. The collation system according to claim 1, wherein
the client comprises a concealing unit which generates the concealed information by concealing input registered information with the public key, and stores the concealed information to the concealed information storage unit.

6. The collation system according to claim 1, wherein
the server comprises:
a key generation unit which generates the secret key and the public key, and
a key sending unit which sends the public key to the client.

7. The collation system according to claim 1, wherein
the secret key and the public key are those in a public key cryptosystem with additive homomorphism.

8. The collation system according to claim 7, wherein
the public key cryptosystem is an additive homomorphism ElGamal encryption.

9. A client which employs a challenge response method, comprises:
a concealed information storage unit which stores concealed information obtained by concealing registered information by use of a public key,
an information generation unit which, on the basis of the concealed information and a random number, generates, by use of the public key, generation source information that is information for generating a challenge, and
a response computation unit which, by use of the challenge sent from the server which employs the challenge response method, collation information to be collated against the registered information, and the random number, computes a response corresponding to the challenge.

10. The client according to claim 9, comprises a concealing unit which generates the concealed information by concealing input registered information with the public key, and stores the concealed information to the concealed information storage unit.

11-14. (canceled)

15. A collation method in a collation system which employs a challenge response method, comprising a client and a server,
wherein the client
stores concealed information obtained by concealing registered information by use of a public key in a concealed information storage unit,
generates, on the basis of the concealed information and a random number, by use of the public key, generation source information that is information for generating a challenge, and
sends generated generation source information to the server,
wherein the server
stores a secret key corresponding to the public key in a key storage unit,
generates the challenge on the basis of the generation source information sent from the client, and
sends generated the challenge to the client, and
wherein the client, by use of the challenge sent from the server, collation information to be collated against the registered information, and the random number, computes a response corresponding to the challenge.

16. A collation method in a client which employs a challenge response method, comprising:
storing concealed information obtained by concealing registered information by use of a public key in a concealed information storage unit,
generating, on the basis of the concealed information and a random number, by use of the public key, generation source information that is information for generating a challenge, and
computing, by use of the challenge sent from the server which employs the challenge response method, collation information to be collated against the registered information, and the random number, a response corresponding to the challenge.

17. (canceled)

18. A non-transitory computer-readable capturing medium having captured therein a program for a client, implemented in a computer comprising a concealed information storage unit which stores concealed information obtained by concealing registered information by use of a public key and performing as the client which employs a challenge response method, causing the computer to execute:
a generating process of generating, on the basis of the concealed information and a random number, by use of the public key, generation source information that is information for generating a challenge, and
a computation process of computing, by use of the challenge sent from the server which employs the challenge response method, collation information to be collated against the registered information, and the random number, a response corresponding to the challenge.

19. (canceled)

20. The collation system according to claim 2, wherein
the registered information and the collation information are expressed by vectors.

21. The collation system according to claim 3, wherein
the registered information and the collation information are expressed by vectors.

22. The collation system according to claim 2, wherein
the client comprises a concealing unit which generates the concealed information by concealing input registered information with the public key, and stores the concealed information to the concealed information storage unit.

23. The collation system according to claim 3, wherein
the client comprises a concealing unit which generates the concealed information by concealing input registered information with the public key, and stores the concealed information to the concealed information storage unit.

24. The collation system according to claim 4, wherein
the client comprises a concealing unit which generates the concealed information by concealing input registered information with the public key, and stores the concealed information to the concealed information storage unit.

25. The collation system according to claim 20, wherein
the client comprises a concealing unit which generates the concealed information by concealing input registered information with the public key, and stores the concealed information to the concealed information storage unit.

26. The collation system according to claim 21, wherein
the client comprises a concealing unit which generates the concealed information by concealing input registered information with the public key, and stores the concealed information to the concealed information storage unit.

27. The collation system according to claim 2, wherein
the server comprises:
a key generation unit which generates the secret key and the public key, and
a key sending unit which sends the public key to the client.

28. The collation system according to claim 3, wherein
the server comprises:
a key generation unit which generates the secret key and the public key, and
a key sending unit which sends the public key to the client.

29. The collation system according to claim 4, wherein
the server comprises:
a key generation unit which generates the secret key and the public key, and
a key sending unit which sends the public key to the client.

30. The collation system according to claim 5, wherein
the server comprises:
a key generation unit which generates the secret key and the public key, and
a key sending unit which sends the public key to the client.

31. The collation system according to claim 20, wherein
the server comprises:
a key generation unit which generates the secret key and the public key, and
a key sending unit which sends the public key to the client.

32. The collation system according to claim 21, wherein
the server comprises:
a key generation unit which generates the secret key and the public key, and
a key sending unit which sends the public key to the client.

33. The collation system according to claim 22, wherein
the server comprises:
a key generation unit which generates the secret key and the public key, and
a key sending unit which sends the public key to the client.

34. The collation system according to claim 23, wherein
the server comprises:
a key generation unit which generates the secret key and the public key, and
a key sending unit which sends the public key to the client.

35. The collation system according to claim 24, wherein
the server comprises:
a key generation unit which generates the secret key and the public key, and
a key sending unit which sends the public key to the client.

36. The collation system according to claim 25, wherein
the server comprises:
a key generation unit which generates the secret key and the public key, and
a key sending unit which sends the public key to the client.
